(19) United States
(12) Patent Application Publication
(10) Pub. No.: US 2026/0095013 A1
(43) Pub. Date: Apr. 2, 2026

(54) LASER DEVICE FOR LASER MODE MANIPULATION

(71) Applicant: LEDlas Corp., Hsinchu City (TW)

(72) Inventor: Yen-Chieh Huang, Hsinchu City (TW)

(73) Assignee: LEDlas Corp., Hsinchu City (TW)

(21) Appl. No.: 18/901,686

(22) Filed: Sep. 30, 2024

(51) Int. Cl. H01S 3/102; H01S 3/091

(52) U.S. Cl. CPC H01S 3/102; H01S 3/091

(57) ABSTRACT

A laser device includes a laser cavity, an end-injection laser, a side-pump source, and a laser-profile shaper. The laser cavity includes a gain medium that is surrounded by a pair of cavity mirrors, and generates an output laser beam of a first wavelength along an axial direction of the laser cavity. The end-injection laser emits an end-injection laser beam of a second wavelength toward the laser cavity in the axial direction. The second wavelength is in an absorption band of the gain medium. The side-pump source provides pump light for the gain medium to generate the output laser beam emitted from the laser cavity. The laser-profile shaper modulates an intensity of the end-injection laser beam, and projects an injection profile of the end-injection laser beam having the spatially-redistributed intensity through the gain medium. The laser cavity generates a laser beam with an output profile mimicking the injection profile.

### FIELD

The disclosure relates to a laser device, and more particularly to a laser device for laser mode manipulation.

### BACKGROUND

A laser is a device that generates coherent optical radiation. The coherence of laser radiation is manifested by a highly collimated beam of radiation and a highly accurate radiation wavelength. Laser beams emitted from a laser cavity may be adjusted or configured to have different transverse profiles suitable for different applications. A laser mode profile is a characteristic energy distribution of the electromagnetic-radiation mode in a laser cavity. In particular, a laser cavity with a pair of flat-flat cavity mirrors surrounding a large-diameter laser rod tends to generate all possible laser transverse modes with complicated laser mode profiles. Although it is possible to use an external-cavity spatial light modulator to convert a profile of an existing laser output to some arbitrary laser mode profile, the post-processing scheme needs to throw away laser power and is not efficient in using the valuable laser energy (see the review paper by A. Forbes et al., “Creation and detection of optical modes with spatial light modulators,” Advances in Optics and Photonics Vol. 8, No. 2, 2016 (200)). It is relatively more efficient to directly generate an arbitrary laser profile inside the laser cavity by using an intracavity spatial light modulator (see, for instance, L Burger et al., “Implementation of a spatial light modulator for intracavity beam shaping,” 2015 J. Opt. 17 015604). However, an intracavity laser power is usually much higher than an emitted laser power. The intracavity spatial light modulator is therefore susceptible to laser damage inside the laser cavity. It is important to have an effective and efficient scheme to overcome the aforementioned drawbacks in the prior arts and to generate a controlled laser profile from a laser cavity for a specific application. In this disclosure, an external laser source and an external-cavity spatial light shaper jointly induce the generation of a desired laser profile from a laser cavity. The present disclosure avoids wasting valuable laser power and prevents intracavity laser damage as in the prior arts, and has the combined advantage of simplicity, efficiency, and effectiveness over the prior arts.

### SUMMARY

Therefore, an object of the disclosure is to provide a laser device for laser mode manipulation that can realize the control of a laser beam profile generated from a laser cavity.

According to the disclosure, a laser device for laser mode manipulation is provided. The laser device includes a laser cavity, an end-injection laser, a side-pump source and a laser-profile shaper. The laser cavity includes a first cavity mirror that is highly reflective at a first wavelength, a second cavity mirror that is spaced apart from the first cavity mirror and that is partially reflective at the first wavelength, and a gain medium that is located between the first cavity mirror and the second cavity mirror. The gain medium is configured to generate laser light at the first wavelength, wherein the laser light travels in an axial direction extending from the first cavity mirror, through the gain medium and to the second cavity mirror. The end-injection laser is configured to emit an end-injection laser beam of a second wavelength toward the laser cavity in the axial direction. The side-pump source is configured to provide pump light to the gain medium in a direction substantially transverse to the axial direction to cause the gain medium to generate an output laser beam of the first wavelength emitted from the second cavity mirror. The laser-profile shaper is disposed between the end-injection laser and the first cavity mirror, and is configured to spatially re-distribute an intensity of the end-injection laser beam and to project an injection profile of the end-injection laser beam having the spatially-redistributed intensity through the first cavity mirror and onto the gain medium. The laser cavity is configured to generate the output laser beam with an output profile mimicking the injection profile of the end-injection laser beam that is projected onto the gain medium. In embodiments, the laser-profile shaper provides fixed or tunable spatial modulation of the end-injection laser beam to optimize the output profile of the output laser beam.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic diagram illustrating an example of an ordinary laser device.

FIG. 2 illustrates a plurality of so-called Hermite-Gaussian mode profiles that are typically generated from an ordinary laser cavity.

FIG. 3 is a schematic diagram illustrating a modified laser device in the prior art with output mode control.

FIG. 4 is a schematic diagram illustrating an alternative version of the modified laser device.

FIG. 5 is a schematic diagram illustrating another modified laser device in the prior art with output mode control.

FIG. 6 is a schematic diagram of a laser device according to a first example of a first embodiment of the disclosure, illustrating laser mode manipulation with an end-injection laser through a fixed-pattern light mask.

FIG. 7 is a schematic diagram of the laser device according to a second example of the first embodiment of the disclosure, illustrating laser mode manipulation with an end-injection laser through a coating on a first cavity mirror.

FIG. 8 illustrates a few examples of laser mode patterns that can be projected by a laser-profile shaper of the laser device according to an embodiment of the disclosure.

FIG. 9 is a schematic diagram of a laser device according to a second embodiment of the disclosure, illustrating laser mode manipulation with an end-injection laser through a tunable laser profile shaper.

FIG. 10 is a schematic diagram of a laser device according to a third embodiment of the disclosure, illustrating laser mode manipulation further including an output image feedback link.

### DETAILED DESCRIPTION

Before the disclosure is described in greater detail, it should be noted that, where considered appropriate, reference numerals or terminal portions of reference numerals have been repeated among the figures to indicate corresponding or analogous elements, which may optionally have similar characteristics.

According to one embodiment of the disclosure, a laser device for laser mode manipulation includes a laser cavity that contains a gain medium between two cavity mirrors, a side-pump source that provides pump energy to the gain medium for generating a laser light of a first wavelength, an end-injection laser that emits an end-injection laser beam of a second wavelength, and a laser-profile shaper that is disposed between the end-injection laser and the laser cavity. The laser-profile shaper receives the end-injection laser beam, spatially modulates the intensity of the end-injection laser beam, and projects a profile (hereinafter referred to as “injection profile”) of the end-injection laser beam at one end of the gain medium in the laser cavity. The laser cavity generates an output laser beam with a profile (hereinafter referred to as “output profile”) mimicking the injection profile. In some embodiments, the end-injection laser beam is absorbed by the gain medium to provide additional laser gain or thermally induced refractive-index modulation in the gain medium. It is noted that, in a multimode laser cavity, such as a large-area flat-flat-mirror cavity, one of a plurality of laser modes that receives the highest gain builds up first and suppresses the other laser modes. The side-pump source provides laser gain to all the laser modes in the laser cavity, whereas the end-injection laser beam that passes through the laser-profile shaper provides additional laser gain or loss modulation to build up a desired laser mode in the laser cavity. In one embodiment, the laser-profile shaper projects a fixed mode-profile pattern to one end of the gain medium. In another embodiment, the laser-profile shaper is an external tunable spatial light modulator projecting a tunable mode-profile pattern to one end of the gain medium. In yet another embodiment, a laser-mode imager disposed at an output of the laser cavity (i.e., at one end of the laser cavity where the output laser beam is emitted) sends a feedback image of the output profile back to the external tunable spatial light modulator via a feedback link to optimize the output profile through an iteration algorithm.

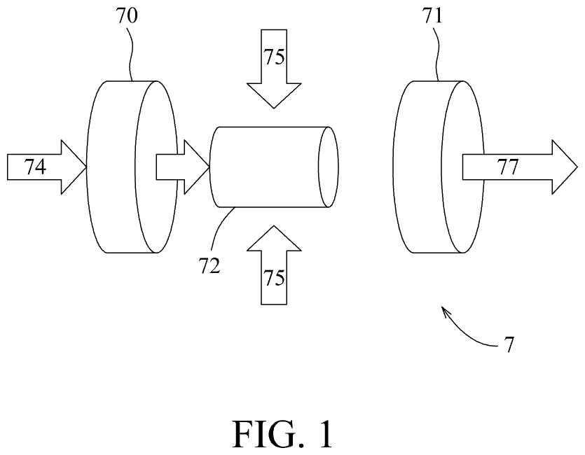

Referring to FIG. 1, an example of an ordinary laser device has a laser cavity 7 that includes a gain medium 72 disposed between a first cavity mirror 70 and a second cavity mirror 71. The gain medium 72 receives end-pump light 74 and/or side-pump light 75 to generate an output laser beam 77 traveling along an axial direction of the laser cavity 7. Usually, the first cavity mirror 70 is highly reflective at an emitting laser wavelength of the output laser beam 77, and the second cavity mirror 71 (or an output coupler) is partially reflective at the emitting laser wavelength. To provide laser gain, wavelengths of both the end-pump light 74 and the side-pump light 75 need to be in a laser-excitation band of the gain medium 72, where the laser-excitation band includes wavelengths at which the end-pump light 74 and the side-pump light 75 are strongly absorbed by the gain medium 72 to generate laser. Light amplification in the laser cavity 7 can be described by a first equation

$$A = \frac{{P}_{o}}{{P}_{i}} = {e}^{( g - α ) L} , \qquad ( Eq . ( 1 ) )$$

where Pᵢ and Pₒ are lights entering and exiting the gain medium 72, respectively, g is a gain coefficient, α is a loss coefficient, and L is a length of the gain medium 72 in the axial direction. The gain coefficient g is a function of pump wavelength and pump-light power. The loss coefficient α is relevant to the absorption, scattering, and output coupling of the second cavity mirror 71. For a laser to achieve oscillation, the laser gain has to exceed the loss (i.e., g>α). In an ordinary laser without mode control, all the laser modes having non-zero net gain (i.e., gₙₑₜ=g−α>0) have a chance to grow and compete to generate the output laser beam 77 with a profile containing the superposition of several mode fields. Although both the end-pump light 74 and the side-pump light 75 can provide laser gain to all possible laser modes, the side-pump light 75 tends to facilitate the growth of high-order transverse modes of the laser cavity 7 in an ordinary laser.

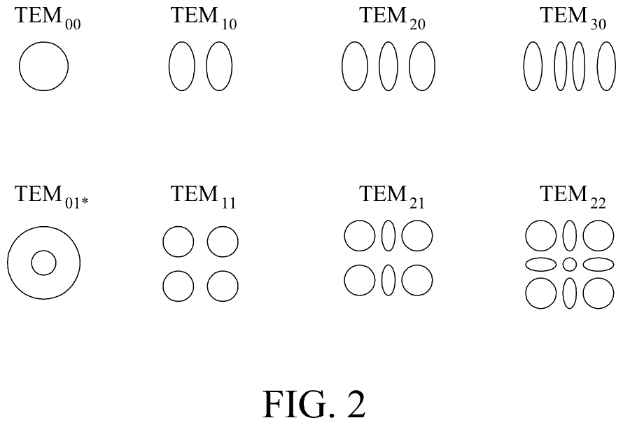

FIG. 2 shows a few so-called Hermite-Gaussian laser mode profiles (denoted by TEMₘₙ) that are eigenmodes of an ordinary laser cavity (e.g., the laser cavity 7) with an x-y symmetry. Specifically, “TEM” stands for “transverse electromagnetic,” and, for each of the laser modes, a pair of integers “m” and “n” indicate the horizontal (x) and vertical (y) orders of the TEMₘₙ laser mode, respectively. For instance, the fundamental transverse mode (i.e., the TEM₀₀ mode) has a circular profile and is useful for machining a circular hole in a material. It should be noted that the first high-order mode, TEM₁₀ or TEM₀₁, has a node in the horizontal direction (m=1) or has a node in the vertical direction (n=1) of the mode profile, respectively. However, since an output profile generated by the laser cavity 7 results from competition among multiple laser modes in the laser cavity 7, to generate an output laser beam with a desired profile, it will be advantageous to have a means of controlling the laser gain and/or loss of the laser modes in the laser cavity 7.

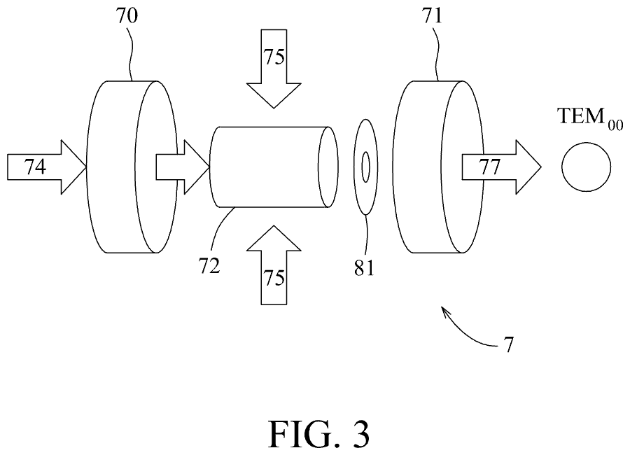

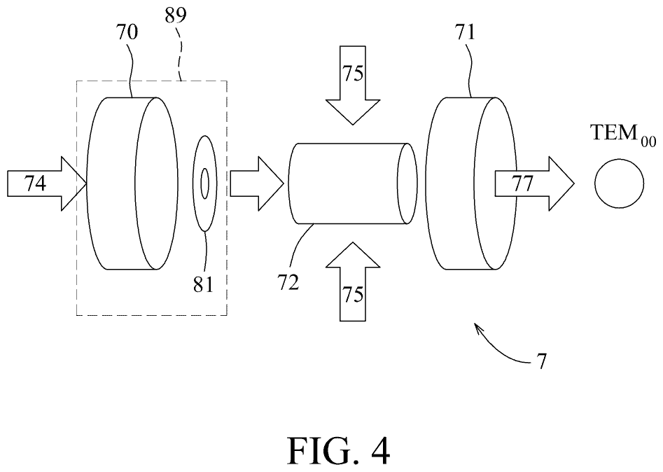

Referring to FIG. 3, a modified laser device in the prior art adopts a spatial filter 81 (or an iris aperture) in the laser cavity 7 of FIG. 1. The spatial filter 81 introduces loss to unwanted laser modes (e.g., the high-order laser modes with large mode areas), thus allowing a low-order laser mode (e.g., the TEM₀₀ mode) to build up from mode competition in the laser cavity 7. In this scheme, Eq. (1) is modified with a spatially dependent loss coefficient α(x, y), given by a second equation

$$A ( x , y ) = \frac{{P}_{o}}{{P}_{i}} = {e}^{[ g - α ( x , y ) ] L} , \qquad ( Eq . ( 2 ) )$$

where the laser amplification has a spatial dependence and some of the laser modes with large mode areas suffer more loss than others. However, in FIG. 3, a portion of the laser light generated by the gain medium 72 in the laser cavity 7 is blocked by the spatial filter 81 in the laser cavity 7, thus decreasing the overall efficiency of laser generation. Furthermore, the spatial filter 81 in the laser cavity 7 is susceptible to laser damage from the high intracavity laser power inside the laser cavity 7. Referring further to FIG. 4, in an alternative version of the modified laser device, the spatial filter 81 and the first cavity mirror 70 are sometimes combined and collectively referred to as a laser-beam shaper 89 (marked by a dashed box in FIG. 4) (see, for instance, L Burger et al., “Implementation of a spatial light modulator for intracavity beam shaping,” 2015 J. Opt. 17 015604) that spatially modulates the laser light that is inside the laser cavity 7 so that the output profile of the output laser beam 77 becomes adjustable. In this scheme, Eq. (2) is again adopted to introduce a spatially dependent amplification in the laser cavity 7 through the spatially dependent loss coefficient α(x, y). However, the high intracavity laser power often causes damage to the surface of the spatial filter 81, since the spatial filter 81 is usually made of fragile liquid crystals or transmissive/reflective micro-structures.

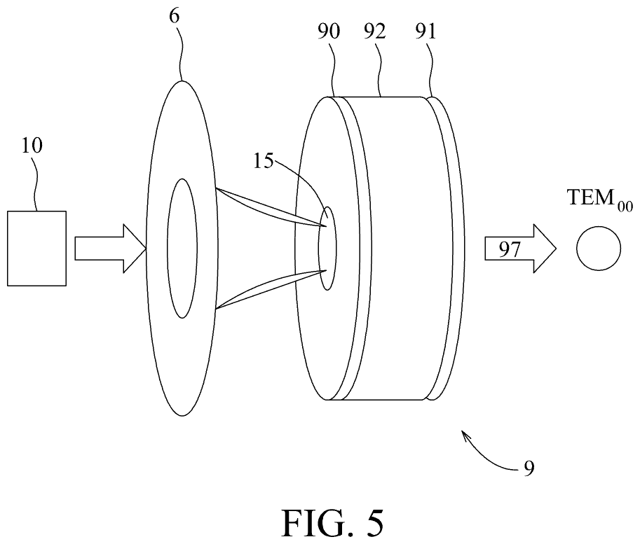

Referring to FIG. 5, another modified laser device in the prior art includes an end-pump source 10, a laser cavity 9 that includes a gain medium 92 disposed between a first surface 90 and a second surface 91, and a focusing lens 6 that is disposed between the laser cavity 9 and the end-pump source 10. The first surface 90 is highly reflective at the emitting laser wavelength, and the second surface 91 is partially reflective at the emitting laser wavelength. The focusing lens 6 focuses the pump light received from the end-pump source 10 into a circular pump spot 15 on the gain medium 92. Usually, the end-pump source 10 is a focusable diode laser configured to emit a laser beam with a wavelength that is in the laser-excitation band of the gain medium 92. The focused diode laser generates heat at the circular pump spot 15 of the gain medium 92. In this scheme, Eq. (2) is modified with an alternative gain coefficient g(I_{TEM}_{₀₀}) favoring the growth of the fundamental TEM₀₀ mode in the laser cavity 9, given by a third equation

$${A}_{{TEM}_{00}} = \frac{{P}_{o}}{{P}_{i}} = {e}^{[ g ( {I}_{{TEM}_{00}} ) - ∝ ) ] L} , \qquad ( Eq . ( 3 ) )$$

where I_{TEM}_{₀₀} is pump intensity at the circular pump spot 15 matched to the fundamental mode profile of the laser cavity 9. In addition, a refractive index of the gain medium 92 has a positive temperature gradient, forming a thermal lens at the circular pump spot 15 to provide a higher gain to the fundamental TEM₀₀ laser mode. One way to increase the power of an output laser beam 97 from the second surface 91 (i.e., to increase a laser emission power) is to ramp up the power of the end-pump source 10. However, such a practice often causes uncontrollable thermal run-away in the gain medium 92 and thus instability in the laser generation. A good laser device should have separate controls for the laser emission power and the output profile.

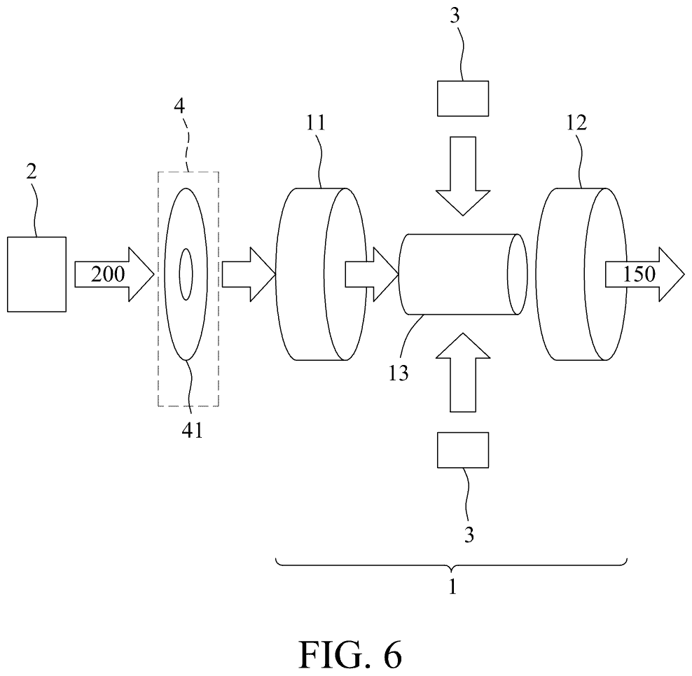

Referring to FIGS. 6 to 8, two examples of a laser device for laser mode manipulation according to a first embodiment of the disclosure are provided. The first embodiment is related to laser mode manipulation with an end-injection laser 2 and a laser-profile shaper 4 that projects a fixed intensity pattern of the end-injection laser 2. In this embodiment, the laser device includes a laser cavity 1 that is capable of emitting an output laser beam 150 at a first wavelength, the end-injection laser 2 that is capable of emitting an end-injection laser beam 200 at a second wavelength, at least one side-pump source 3, and the laser-profile shaper 4. In the first embodiment, two side-pump sources 3 are exemplified in FIG. 6.

The laser cavity 1 includes a first cavity mirror 11 that is optically coated to be highly reflective at the first wavelength and to be transmissive at the second wavelength, a second cavity mirror 12 that is spaced apart from the first cavity mirror 11 and that is partially reflective at the first wavelength, and a gain medium 13 that is installed between the first cavity mirror 11 and the second cavity mirror 12 to receive pump light from the side-pump source(s) 3. In this embodiment, the first cavity mirror 11 is a high reflector for the first wavelength. The gain medium 13, excited by the pump light emitted by the side-pump source(s) 3, provides gain to the laser cavity 1 to generate the output laser beam 150. The output laser beam travels in an axial direction of the laser cavity 1 and is emitted from the second cavity mirror 12. In this embodiment, the gain medium 13 may be a neodymium-doped yttrium aluminum garnet (Nd:YAG) crystal, a neodymium-doped yttrium aluminum perovskite (Nd:YAP) crystal, an ytterbium-doped YAG (Yb:YAG) crystal, a holmium-chromium-thulium triple-doped YAG (Ho/Cr/Tm:YAG) crystal, a neodymium-doped yttrium orthovanadate (Nd:YVO4) crystal, an erbium-doped YAG (Er:YAG) crystal, a chromium-doped colquiriite (Cr:LiSAF) crystal, a titanium-doped sapphire (Ti:sapphire) crystal, a chromium/erbium doped yttrium scandium gallium garnet (Cr/Er:YSGG) crystal, an alexandrite crystal, or an erbium-doped glass (Er:glass) crystal.

The end-injection laser 2 is configured to emit the end-injection laser beam 200 toward the laser cavity 1 along the axial direction. Each side-pump source 3 is configured to provide energy of the pump light (hereinafter referred to as “pump energy”) to the gain medium 13 in a direction substantially transverse to the axial direction to excite the gain medium 13, so that the gain medium 13 generates laser light inside the laser cavity 1. In this embodiment, each side-pump source 3 is a light-emitting diode (LED), a flashlamp, or a laser diode that emits the pump light at a wavelength that is in a laser-excitation band of the gain medium 13. To describe in further detail, the laser-excitation band includes a plurality of laser-excitation wavelengths. When the wavelength of the pump light matches one of the laser-excitation wavelengths of the gain medium 13, the gain medium 13 absorbs the pump light and amplifies the laser light in the laser cavity 1, thus building up the output laser beam 150 from the laser cavity 1. In some embodiments, there may be multiple side-pump sources 3 illuminating (i.e., providing the pump light to) the gain medium 13 simultaneously.

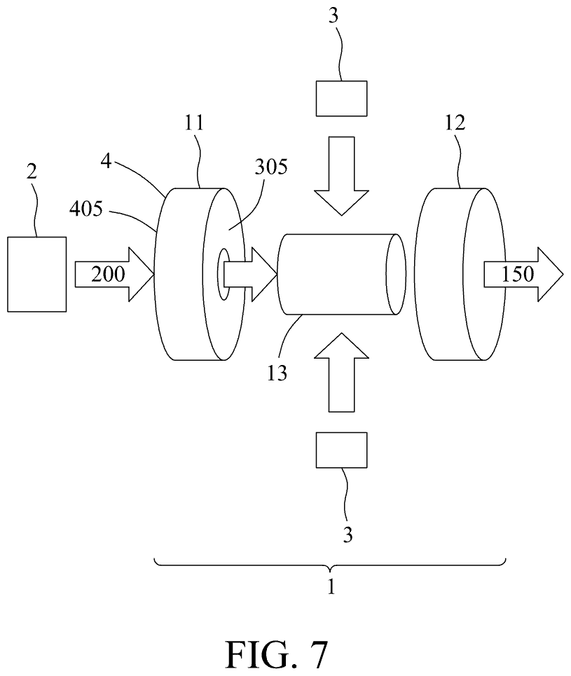

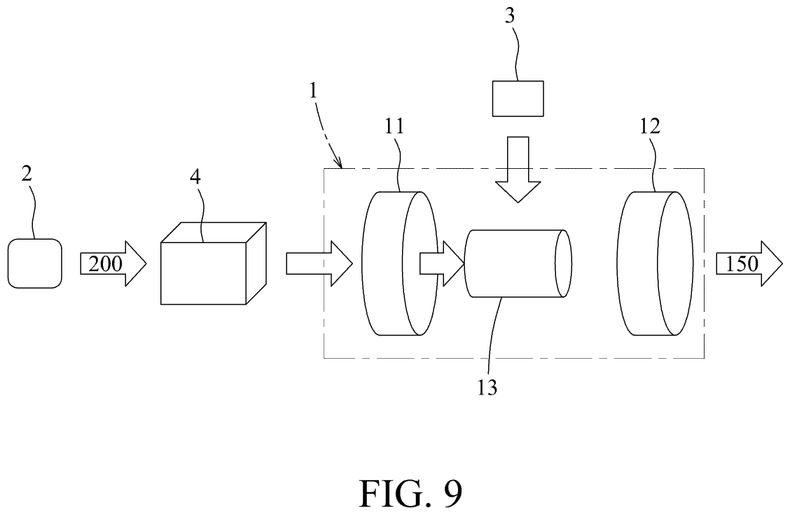

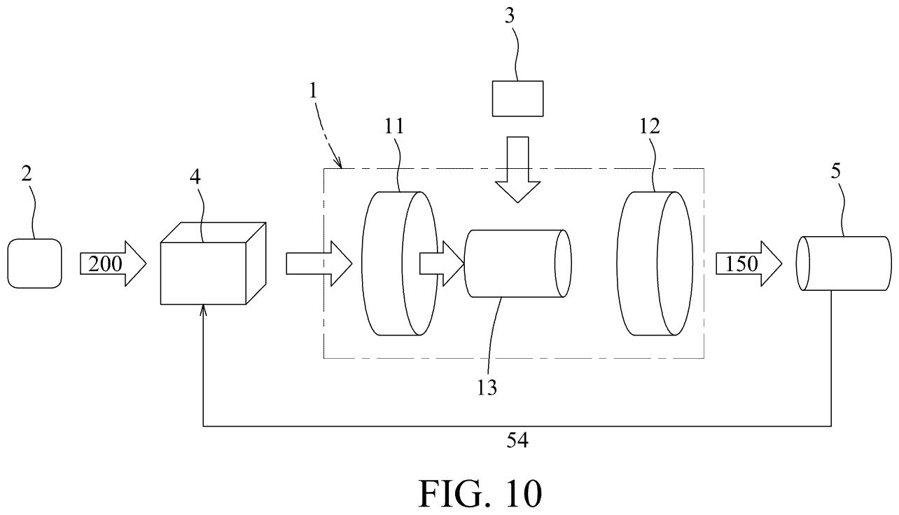

The laser-profile shaper 4 is disposed between the end-injection laser 2 and the first cavity mirror 11, and the end-injection laser 2 is located at a side of the first cavity mirror 11 opposite to the gain medium 13. The laser-profile shaper 4 is configured to spatially re-distribute an intensity of the end-injection laser beam 200 so as to project the end-injection laser beam 200 with an injection profile onto one end of the gain medium 13. The present disclosure discloses a new laser amplification mechanism improved from Eq. (1), given by the spatially dependent amplification in a fourth equation

$$A ( x , y ) = \frac{{P}_{o}}{{P}_{i}} = {e}^{[ G ( {I}_{s} ) + g ( {I}_{e} ( x , y ) ) - α ) ] L} , \qquad ( Eq . ( 4 ) )$$

where G(Iₛ) is a primary laser gain coefficient provided by the side-pump source 3 with a uniform pump intensity Iₛ, and g(Iₑ(x, y)) is a spatially modulated gain coefficient depending on an intensity Iₑ(x, y) of the end-injection laser beam 200 through the laser-profile shaper 4 that is disposed externally to the laser cavity 1 in FIGS. 6 and 7 or a spatial light modulator in FIGS. 9 and 10 (which will be describe in further detail later). Owing to the exponential amplification in a laser cavity 1, a small spatially modulated gain coefficient g(Iₑ(x, y)) is sufficient to control an outputted laser profile. Furthermore, in some laser gain materials, such as Nd:YAG or Nd:YVO4 etc., exhibiting thermally induced refractive-index change or gain bleaching (to be explained below), the spatially modulated end-injection laser beam, when absorbed by the gain medium 13 to generate heat, can induce a spatial thermal profile and thus a spatially dependent loss coefficient α(Iₑ(x, y)) in the gain medium 13. Equation (1) is therefore further modified to be a fifth equation

$$A ( x , y ) = \frac{{P}_{o}}{{P}_{i}} = {e}^{[ G ( {I}_{s} ) - α ( {I}_{e} ( x , y ) ) ] L} . \qquad ( Eq . ( 5 ) )$$

In this case, the wavelength of the end-injection laser beam 200 is in an absorption band of the gain medium 13, which includes the laser-excitation band, but the wavelength is not necessarily in the laser-excitation band of the gain medium 13. It should be noted that the absorption band includes wavelengths of light that are easily absorbed by the gain medium 92. The laser-excitation band is a wavelength band useful for laser excitation in the absorption band of a gain medium (e.g., the gain medium 92). Again, owing to the exponential amplification in a laser cavity 1, the spatially dependent loss coefficient α(Iₑ(x, y)) is sufficient to control the outputted laser profile.

The spatially modulated gain coefficient g(Iₑ(x, y)) and the spatially dependent loss coefficient α(Iₑ(x, y)) in Eqs. (4) and (5) are flexibly controlled by the end-injection laser beam 200, which offers an effective means to generate a desirable laser profile at the output of the laser cavity 1.

Referring to FIG. 6, in a first example of the first embodiment, the laser-profile shaper 4 is a fixed-pattern light mask 41 that is disposed externally to the laser cavity 1, spatially re-distributes the intensity of the end-injection laser beam 200, and projects the end-injection laser beam 200 with a desired laser profile onto the gain medium 13 to force the laser cavity 1 to oscillate at a desired laser mode corresponding to the desired mode profile. It is noted that the desired laser profile may be set by a user-defined light mask (i.e., the fixed-pattern light mask 41). Since the fixed-pattern light mask 41 is installed externally to the laser cavity 1, the fixed-pattern light mask 41 will not be damaged by the intense laser power inside the laser cavity 1. Furthermore, since the laser power of the output laser beam 150 is primarily supplied by the side-pump source(s) 3, the end-injection laser 2 may be used solely for controlling and optimizing an output profile of the output laser beam 150.

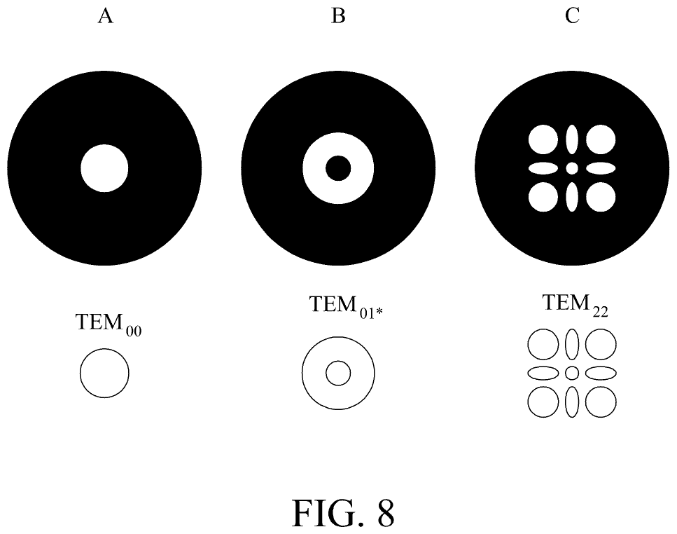

Referring to FIG. 7, in a second example of the first embodiment, the laser-profile shaper 4 is combined with the first cavity mirror 11. Specifically, the laser-profile shaper 4 is coated on the first cavity mirror 11. In this embodiment, the first cavity mirror 11 is a patterned dichroic mirror that is configured to be transmissive at the second wavelength and to be reflective at the first wavelength. Such patterned dichroic mirror can be fabricated by involving both thin-film coating and lithographic patterning technologies. For instance, a dichroic coating that is highly reflective at the first wavelength and highly transmissive at the second wavelength is first fabricated on an intracavity mirror surface 305 of the first cavity mirror 11. An optical coating that is highly reflective at the second wavelength is fabricated on the external-cavity mirror surface 405 of the first cavity mirror 11. Finally, the optical coating on the external-cavity mirror surface 405 is etched to form the fixed-pattern light mask 41 for the end-injection laser 2 by using lithographic patterning technology. The end-injection laser beam 200 at the second wavelength can then transmit through both the patterned external-cavity mirror surface 405 (i.e., through the etched portion) and the intracavity mirror surface 305, and be projected, with the desired laser profile, on one end of the gain medium 13. FIG. 8 illustrates a few possible laser mode patterns (A, B, and C) that can be projected by the laser-profile shaper 4 (the top row of FIG. 8), and their corresponding output profiles from the laser cavity 1 (the bottom row of FIG. 8). In this embodiment, the laser-profile shaper 4 is the fixed-pattern light mask 41 coated on the external-cavity mirror surface 405 and is external to the laser cavity 1.

To describe the embodiment in FIG. 7 in further detail, the patterned dichroic mirror (i.e., the first cavity mirror 11 of the second example of the first embodiment) transmits the end-injection laser beam 200 with an intensity profile defined by the laser-profile shaper 4 to the laser cavity 1, and reflects to resonate the laser light generated by the gain medium 13 inside the laser cavity 1. The second cavity mirror 12 is an output coupler that is partially reflective for the laser light generated by the gain medium 13. Therefore, the output coupler permits a portion of the laser light to exit the laser cavity 1 as the output laser beam 150. Since the end-injection laser beam 200 with a pattern modulated by the laser-profile shaper 4 increases the net gain of the desired laser mode in the laser cavity 1, the desired laser profile is selectively built up inside the laser cavity 1, and the output laser beam 150 is generated with the desired laser profile.

In one example, the laser-profile shaper 4 is configured to, if the desired laser profile for the laser output beam 150 is the TEM₀₀ laser mode, project the end-injection laser beam 200 with the injection profile that has a circular spot through the first cavity mirror 11 and then onto one end of the gain medium 13. Preferably, a size of the circular spot projected by the laser-profile shaper 4 matches a circular area of the oscillating TEM₀₀ mode in the laser cavity 1.

In some embodiments, the second wavelength of the end-injection laser beam 200 emitted by the end-injection laser 2 matches one of the absorption wavelengths in the laser-excitation band of the gain medium 13, and, by virtue of Eq. (4), the energy in the end-injection laser beam 200 with the injection profile helps the laser cavity 1 to build up the desired laser mode that has a profile similar to the injection profile, so the laser cavity 1 generates the output laser beam 150 with the desired laser profile. In some embodiments, the second wavelength of the end-injection laser beam 200 emitted by the end-injection laser 2 matches one of the absorption wavelengths of the gain medium 13 and the absorption wavelength is not in the laser-excitation band of the gain medium 13. For instance, the end-injection laser 2 is a CO₂ laser that is strongly absorbed by, for instance, a Nd:YAG laser gain medium but does not contribute to pumping an Nd:YAG laser. The absorption of the end-injection laser beam 200 by the gain medium 13 may induce thermal scattering or thermal gain bleaching in the gain medium 13. To describe in further detail, thermal scattering of light is related to thermally induced refractive-index change in the gain medium 13, and thermal gain bleaching occurs when the ground-state atoms of the gain medium 13 are excited to a higher energy level by the thermal energy and the population inversion necessary for laser operation is no longer maintained. Therefore, thermal scattering and thermal gain bleaching are useful for manipulating the laser loss of different laser modes in the laser cavity according to Eq. (5). It should be noted that the pump energy for generating the output laser beam 150 mainly relies on the pump light provided by the side-pump source(s) 3. Therefore, the end-injection laser 2 can be configured to be relatively low-power and, if necessary, can be used solely for controlling or optimizing the output profile at the output of the laser cavity 1.

In some embodiments, the laser-profile shaper 4 is configured to project the end-injection laser beam 200 with a high-order mode profile (i.e., the TEMₘₙ modes with nonzero “m” and “n” in FIG. 2) through the first cavity mirror 11 and then onto the gain medium 13. The end-injection laser beam 200 with the injection profile of the high-order mode profile can re-distribute the net gain of different laser modes in the laser cavity 1, and preferentially build up the output profile mimicking the high-order mode profile. In other embodiments, the laser-profile shaper 4 is configured to project the end-injection laser beam 200 with a user-desired profile for some specific application. In such a case, the injection profile (i.e., the user-desired profile) of the end-injection laser beam 200 may be selected such that it induces oscillation of multiple TEMₘₙ modes in the laser cavity 1 to generate the output profile mimicking the user-desired profile, where the output profile matches a specific application.

Referring further to FIG. 9, the laser device for laser mode manipulation according to a second embodiment of the disclosure is provided. The second embodiment is related to laser mode manipulation with the end-injection laser 2 and the laser-profile shaper 4 that projects a tunable pattern. The second embodiment is similar to the first embodiment, and their difference resides in that the laser profile shaper 4 of the second embodiment is tunable. In the second embodiment, the laser device is the same as the first example of the first embodiment (as in FIG. 6), except that the fixed-pattern light mask 41 is replaced by a pixel-addressable spatial light modulator, which is capable of tuning the injection profile for controlling or optimizing the output profile. The pixel-addressable spatial light modulator may include, for example, a display controller or a display driver and a reflective liquid-crystal display (LCD) or a transmissive LCD, and is capable of projecting an arbitrary profile of the end-injection laser beam 200 through the first cavity mirror 11 and then onto one end of the gain medium 13. Unlike the fixed-pattern light mask 41 (see FIG. 6) or the patterned dichroic mirror in the first embodiment, the pixel-addressable spatial light modulator offers flexibility in projecting a tunable end-injection laser profile into the laser cavity 1 for applications demanding tunability.

Referring further to FIG. 10, the laser device for laser mode manipulation according to a third embodiment of the disclosure is provided. The third embodiment is related to laser mode manipulation that further uses an output image feedback link. The third embodiment is similar to the second embodiment, and their difference resides in that the third embodiment further includes a laser-mode imager 5 and a feedback link 54, which are disposed at the output of the laser cavity 1 (i.e., at one end of the laser cavity 1 where the output laser beam 150 is emitted). Specifically, the laser-mode imager 5 and the feedback link 54 form a feedback loop.

To describe in further detail, the laser-mode imager 5 includes an image sensor that is configured to obtain a feedback image of the output profile from the laser cavity 1, and to provide the feedback image of the output profile to the laser-profile shaper 4 via the feedback link 54 in real-time. In this embodiment, the image sensor may be, for example, a camera, and the feedback link 54 may be, for example, a signal cable capable of sending data of the feedback image back to the laser-profile shaper. In this embodiment, the laser-profile shaper 4 is further configured to iteratively adjust the injection profile of the end-injection laser beam 200 based on the data of the feedback image using an iteration algorithm, so that the output profile generated by the laser cavity 1 gradually approaches to the desired laser profile. Specifically, the iteration algorithm is performed by the laser-profile shaper 4 to spatially modulate the intensity of the end-injection laser beam 200 based on a comparison of a target profile and the feedback image returned from the feedback link 54, such that the injection profile of the end-injection laser beam 200 gradually approaches the target profile. It is noted that the target profile helps build up the desired laser profile for the output laser beam 150. In this embodiment, the iteration loop starts from the laser-profile shaper 4 projecting the end-injection laser beam 200 with the injection profile to the laser cavity 1, the laser-mode imager 5 capturing the output profile (i.e., as the feedback image), the feedback link 54 returning the captured image (i.e., the feedback image) to the laser-profile shaper 4, the laser-profile shaper 4 comparing the target profile and the returned image (i.e., the feedback image), and the laser-profile shaper 4 projecting the end-injection laser beam 200 with a modified injection profile that is closer to the target profile, so as to gradually obtain the output laser beam 150 with the desired laser profile after a few iterations.

Compared to some conventional laser devices, which receive the pump energy solely from an end-injection laser beam and suffer from thermal instability at a high pump power, the laser device of this disclosure receives the pump energy primarily from the side-pump source(s) 3. Since the side-pump source(s) 3 provides (provide) sufficient energy for laser generation in the laser cavity 1, the end-injection laser 2 for manipulating the output profile may be relatively low-power and is mostly decoupled from basic laser operations, such as laser threshold, laser efficiency, laser stability, and output laser power, etc. Of course, below the onset of thermal instability of the laser cavity 1, the end-injection laser 2, while controlling the output profile of the laser cavity 1, may also serve as a booster pump source to increase the overall laser output power, if the wavelength of the end-injection laser 2 is one of the wavelengths in the laser-excitation band of the gain medium 13. Such a design is advantageous in simplifying the operation of a laser system when both laser performance (e.g., laser power of the output laser beam 150) and a desired laser profile are required for a specific application.

In summary, the laser device of the disclosure includes the laser-profile shaper 4 that is exterior to the laser cavity 1, and that is capable of manipulating the output profile by adjusting the injection profile of the end-injection laser beam 200. With the addition of the laser-mode imager 5 and the feedback link 54 to the laser device, the laser-profile shaper 4 may further iteratively control or optimize the injection profile in real-time based on the feedback image obtained by the laser-mode imager 5 and the feedback link 54. Furthermore, since the side-pump source(s) 3 provides (provide) the pump energy sufficient to generate the output laser beam 150, the wavelength of the end-injection laser beam 200 is not restricted to be one of the laser-excitation wavelengths of the gain medium 13. In one example, thermally induced refractive-index modulation can be achieved in an Nd:YNO4 gain medium by using both an 808-nm end-injection laser or a CO₂ end-injection laser, where the wavelength of the CO₂ end-injection laser is not one of the laser-excitation wavelengths of an Nd:YVO4 crystal.

The present disclosure adopts external-cavity elements, including the laser-profile shaper 4, the end-injection laser 2, the laser-mode imager 5, the feedback link 54, etc., to manipulate the laser modes of the laser cavity 1 and to control the output profile of the output laser beam 150. Unlike those in the prior arts adopting intra-cavity elements for laser mode manipulation, the external-cavity scheme of the present disclosure avoids material damage by the intense laser power inside the laser cavity 1. Another important feature of the present disclosure is to externally inject the end-injection laser beam 200 with the injection profile into the laser cavity 1 to preferentially build up the desired laser profile through net-gain (the gain coefficient minus the loss coefficient) control of the laser modes in the laser cavity 1. The exponential growth of a lasing process allows a small gain/loss perturbation in the laser cavity 1 to selectively build up some laser mode in the laser cavity 1. Unlike some prior arts adopting an external-cavity mode converter that throws away valuable laser power for laser mode conversion, the present disclosure is relatively more efficient, effective, and straightforward in generating the desired laser profile from the laser cavity.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A laser device for laser mode manipulation, comprising:
a laser cavity including a first cavity mirror that is highly reflective at a first wavelength, a second cavity mirror that is spaced apart from said first cavity mirror and that is partially reflective at the first wavelength, and a gain medium that is located between said first cavity mirror and said second cavity mirror, and that is configured to generate laser light at the first wavelength, wherein the laser light travels in an axial direction extending from said first cavity mirror, through said gain medium and to said second cavity mirror;
an end-injection laser configured to emit an end-injection laser beam of a second wavelength toward said laser cavity in the axial direction;
a side-pump source configured to provide pump light to said gain medium in a direction substantially transverse to the axial direction to cause said gain medium to generate an output laser beam of the first wavelength emitted from said second cavity mirror; and
a laser-profile shaper disposed between said end-injection laser and said first cavity mirror, and configured to spatially re-distribute an intensity of the end-injection laser beam and to project an injection profile of the end-injection laser beam having the spatially-redistributed intensity through said first cavity mirror and onto said gain medium;
wherein said laser cavity is configured to generate the output laser beam with an output profile mimicking the injection profile of the end-injection laser beam that is projected onto said gain medium.

2. The laser device according to claim 1, wherein the second wavelength of said end-injection laser is in an absorption band of said gain medium.

3. The laser device according to claim 1, wherein said gain medium absorbs energy of the end-injection laser beam to induce one of spatially modulated laser gain and loss in said gain medium.

4. The laser device as claimed in claim 1, wherein said gain medium is a crystal selected from among Nd:YAG, Nd:YAP, Yb:YAG, Ho/Cr/Tm:YAG, Nd:YVO4, Er:YAG, Cr:LiSAF, Ti:sapphire, Cr/Er:YSGG, Alexandrite, and Er:glass crystals.

5. The laser device according to claim 1, wherein said side-pump source is one of a light-emitting diode (LED), a flashlamp, and a laser diode that is configured to emit the pump light at a wavelength in a laser-excitation band of said gain medium.

6. The laser device according to claim 1, wherein said laser-profile shaper is a fixed-pattern light mask that is configured to transmit the end-injection laser beam with a desired laser profile onto said gain medium.

7. The laser device according to claim 6, wherein said fixed-pattern light mask is fabricated on a surface of said first cavity mirror.

8. The laser device according to claim 1, wherein said laser-profile shaper is a pixel-addressable spatial light modulator that is configured to transmit the end-injection laser beam with a desired laser profile onto said gain medium, where the desired laser profile is tunable by the pixel-addressable spatial light modulator.

9. The laser device according to claim 8, further comprising a laser-mode imager and a feedback link that are disposed exterior to said laser cavity.

10. The laser device according to claim 9, wherein said laser-mode imager includes an image sensor that is configured to obtain a feedback image of the output profile emitted from said second cavity mirror, and to send the feedback image to said laser-profile shaper via said feedback link.

11. The laser device according to claim 10, wherein said laser-profile shaper is further configured to adjust the injection profile of the end-injection laser beam based on the feedback image using an iteration algorithm that includes comparing the desired laser profile and the feedback image of the output profile.

12. The laser device according to claim 1, further comprising a laser-mode imager and a feedback link that are disposed exterior to said laser cavity.

13. The laser device according to claim 12, wherein said laser-mode imager includes an image sensor that is configured to obtain a feedback image of the output profile emitted from said second cavity mirror, and to send the feedback image to said laser-profile shaper via said feedback link.

14. The laser device according to claim 13, wherein said laser-profile shaper is configured to transmit the end-injection laser beam with a desired laser profile onto said gain medium, and said laser-profile shaper is further configured to adjust the injection profile of the end-injection laser beam based on the feedback image using an iteration algorithm that includes comparing the desired laser profile and the feedback image of the output profiles.
